(19) United States
(12) Patent Application Publication
(10) Pub. No.: US 2021/0349248 A1
(43) Pub. Date: Nov. 11, 2021

(54) A MULTI-LAYER FILM AND DISPLAY SYSTEM

(71) Applicant: 3M INNOVATIVE PROPERTIES COMPANY, St. Paul, MN (US)

(72) Inventors: Eileen M. Franey, Woodbury, MN (US); Stephan J. Pankratz, Eagan, MN (US); John F. VanDerlofske, III, Minneapolis, MN (US); Matthew B. Johnson, Woodbury, MN (US)

(21) Appl. No.: 17/250,872

(22) PCT Filed: Oct. 9, 2019
(86) PCT No.: PCT/IB2019/058596

§ 371 Date: Mar. 17, 2021

Related U.S. Application Data
(60) Provisional application No. 62/747,711, filed on Oct. 19, 2018.

(51) Int. Cl. G02B 5/30

(52) U.S. Cl. CPC G02B 5/3041; B60R 1/089; G02B 5/3083

(57) ABSTRACT

Embodiments of the present disclosure relate to a multi-layer film and display system. The multi-layer film and display system includes a birefringent film, wherein the birefringent film substantially reduces a visibility of a regular optical pattern generated on the multi-layer film and display system when an at least partially polarized light is incident on the multi-layer film and display system.

### TECHNICAL FIELD

The disclosure generally relates to multi-layer films and display systems.

### BACKGROUND

Conventional inner/top rear view mirror, inside a vehicle, has been replaced with a liquid crystal display (LCD) mirror or an E-mirror. However, both the conventional inner rear view mirror and LCD mirror face an undesirable optical pattern, or white dot pattern problem. A viewer viewing the rear view mirror may observe a plurality of white dots when a reflection of light either from at least one trailing vehicle or from a road surface falls on a rear window of a leading vehicle (as shown in FIG. 1). This white dot pattern appearance is a normal and regular optical phenomenon, and occurs due to unevenness of photo elasticity in the rear window glass. This unevenness originates due to a manufacturing process for hardening of the rear window glass. Since, the use of such hardened rear window glass is unavoidable, a technique to reduce the visibility of the regular optical pattern on the rear view mirror is required.

### SUMMARY

Various aspects and embodiments described herein relate to a multi-layer film and a display system which reduce or eliminate visibility of white dot regular optical pattern.

An aspect of the present disclosure relates to a display system including a display configured to emit an image. A birefringent film is disposed on the display and has a retardance of at least 20, or 50, or 75, or 100, or 150, or 200, or 300, or 400, or 500 nm at a visible wavelength. A reflective polarizer is disposed between the display and the birefringent film. The reflective polarizer is configured to transmit the image emitted by the display, substantially reflect a first polarization state, and substantially transmit an orthogonal second polarization state.

Another aspect of the present disclosure relates to a display system including a display configured to emit an image A birefringent film is disposed on the display and configured to depolarize an incident polarized light by at least 10%, or 20%, or 30%, or 40%, or 50%, or 60%, or 70%, or 80%, or 90%. A reflective polarizer is disposed between the display and the birefringent film. The reflective polarizer is configured to transmit the image emitted by the display, substantially reflect a first polarization state, and substantially transmit an orthogonal second polarization state.

Another aspect of the present disclosure relates to a display system including a display configured to emit light polarized along a second polarization state. A birefringent film is disposed on the display and has an orthogonal in-plane first and second optical axes. The first optical axis makes an angle between about 20 degrees and about 60 degrees with the second polarization state. A reflective polarizer is disposed between the display and the birefringent film. The reflective polarizer is configured to transmit the image emitted by the display, substantially transmit the second polarization state, and substantially reflect an orthogonal first polarization state.

Another aspect of the present disclosure relates to a display system including a display emitting an image. A birefringent film is disposed on the display such that the birefringent film substantially reduces a visibility of a regular optical pattern generated on the display system when an at least partially polarized light in a wavelength range extending at least from about 450 nm to about 700 nm is substantially normally incident on the display system.

Yet another aspect of the present disclosure relates to a display system including a display configured to emit polarized light. A birefringent film is disposed on the display and is configured to receive the emitted polarized light. A partial reflector is disposed between the display and the birefringent film, such that when viewed through a polarizing film, the birefringent film substantially reduces a visibility of a regular optical pattern generated on the display system when an at least partially polarized light in a wavelength range extending at least from about 450 nm to about 700 nm is substantially normally incident on the display system.

Yet another aspect of the present disclosure relates to a multilayer film including a partial reflector, and a birefringent film optically coupled to the partial reflector, such that, when viewed through a polarizing film, the birefringent film substantially reduces a visibility of a regular optical pattern generated on the multilayer film when an at least partially polarized light is incident on the multilayer film

These and other aspects of the present application will be apparent from the detailed description below. In no event, however, should the above summaries be construed as limitations on the claimed subject matter, which subject matter is defined solely by the attached claims.

### BRIEF DESCRIPTION OF DRAWINGS

The various aspects of the disclosure will be discussed in greater detail with reference to the accompanying figures where,

FIG. 1 schematically shows a trailing vehicle and road surface reflecting light on a rear window glass of a leading vehicle;

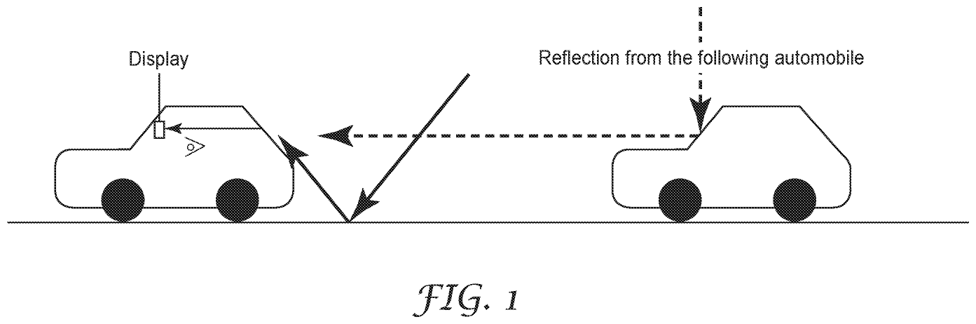

FIG. 2 schematically shows an exploded view of a multi-layer film;

FIG. 3 schematically shows an exploded view of a display system in accordance to an embodiment;

FIG. 4 schematically shows an exploded view of a display system in accordance to an embodiment;

FIG. 5 schematically shows an exploded view of a display system in accordance to an embodiment; and

FIG. 6 schematically shows an exemplary embodiment of the disclosure.

The figures are not necessarily to scale. Like numbers used in the figures refer to like components. However, it will be understood that the use of a number to refer to a component in a given figure is not intended to limit the component in another figure labelled with the same number.

### DETAILED DESCRIPTION OF ILLUSTRATIVE EMBODIMENTS

The present disclosure relates to a multi-layer film which substantially reduces a visibility of a white dot pattern by using a birefringent film. The present disclosure also relates to a display system which also substantially reduces the visibility of a white dot pattern by using the birefringent film.

As used herein below, the white dot pattern may be referred to as “a regular optical pattern”. The regular optical pattern may include alternating darker and brighter regions. The regular optical pattern may be a periodic pattern. Further, the regular optical pattern may be a two-dimensional periodic pattern.

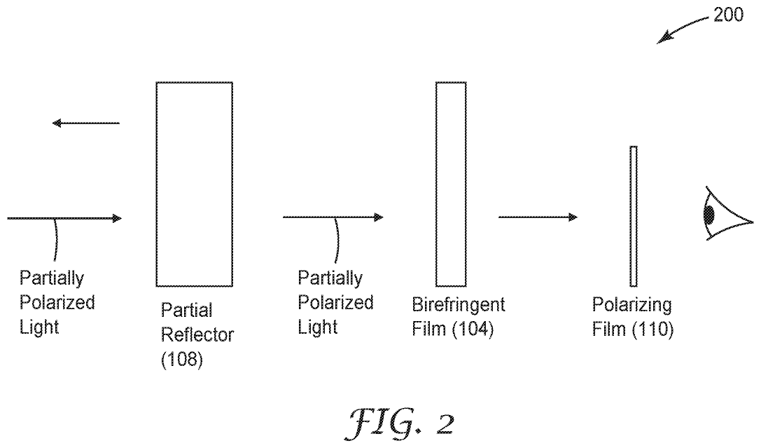

FIG. 2 shows a multi-layer film (200) which is configured to substantially reduce the visibility of the regular optical pattern. The multi-layer film (200) substantially reduces the visibility of the regular optical pattern generated on the multilayer film (200) when an at least partially polarized light is incident on the multilayer film (200). The at least partially polarized light may have a wavelength range extending at least from 450 nm to about 750 nm. The at least partially polarized light may be incident substantially normally on the multi-layer film (200).

The multi-layer film (200) includes a partial reflector (108), and a birefringent film (104). The multi-layer film (200) may be a uni-body film having the partial reflector (108) and the birefringent film (104) optically coupled with each other. The partial reflector (108) and the birefringent film (104) may be bonded to each other using an adhesive.

The partial reflector (108) is configured to transmit incident polarized light to the birefringent film (104). The partial reflector (108) may transmit at least 30% of normally incident polarized light to the birefringent film (104). In some embodiments, the partial reflector (108) may reflect at least 80% of normally incident polarized light. The partial reflector (108) may be a conventional partial reflector known to a person ordinary skilled in the art.

The birefringent film (104) is configured to depolarize the incident polarized light received from the partial reflector (108). The birefringent film (104) may further transmit the depolarized light to a viewer viewing using a polarizing film (110). The polarizing film (110) may include, but not limited to, a hand-held polarizing film and/or a polarizing spectacle. The birefringent film (104) may have a uniform or non-uniform thickness. The birefringent film (104) may have an average thickness greater than about 50 microns. In some embodiments, the birefringent film (104) may have an average thickness greater than about 100 microns. In some embodiments, the birefringent film (104) has an average thickness greater than about 200 microns. Further, the birefringent film (104) may have a different refraction index in different directions. The birefringent film (104) may have a retardance value of at least --- nm at a visible wavelength. In some embodiments, the birefringent film (104) may have a retardance value of at -- nm at a -- wavelength. Further, the birefringent film (104) may depolarize the incident polarized light by at least --%. In an embodiment, the birefringent film (104) may depolarize the incident polarized light by --%. Further, the birefringent film (104) may be disposed at an angle on the partial reflector (108) or any display (as described herein below) where the regular optical pattern is generated. The birefringent film (104) may also have an orthogonal in-plane first axis (105) and second (107) optical axes. Furthermore, the birefringent film (104) is configured to substantially reduce the visibility of the regular optical pattern generated on the multi-layer film (200), when viewed through the polarizing film (110), when the at least partially polarized light is incident on the partial reflector (112).

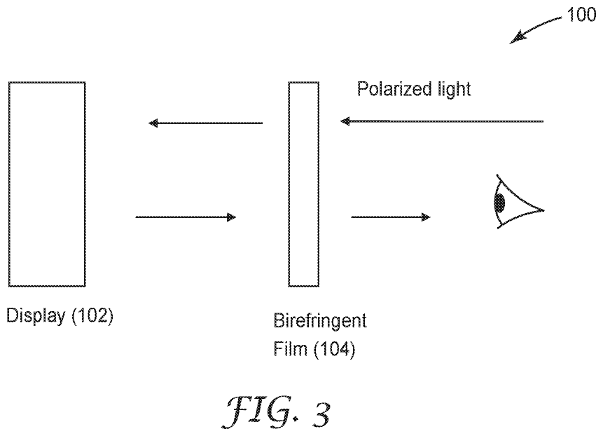

In another embodiment, as shown in FIG. 3, the birefringent film (104) may be directly bonded to a display (102) using an adhesive layer known to a person ordinary skilled in the art. The birefringent film (104) bonded to the display (102) may form a display system (100). In certain embodiments, the display (102) may include a rear view LCD display, an E-mirror, and/or a top rear view mirror and configured to emit an image. The display (102) may receive the partially polarized light substantially normally from a rear window glass of the vehicle or any light source which generates a regular optical pattern. The at least partially polarized light may have a wavelength range extending at least from 450 nm to about 750 nm. Further, the display (102) is configured to emit the at least partially polarized light towards the birefringent film (104) which reduces the visibility of the regular optical pattern generated on the display (102).

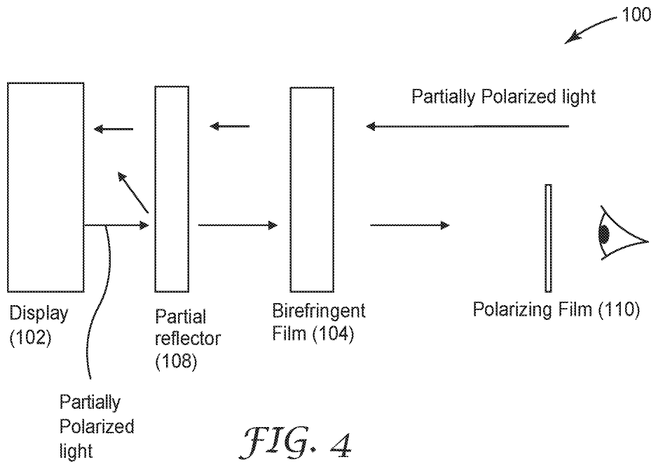

In another embodiment, as shown in FIG. 4, the partial reflector (108) may be disposed between the display (102) and the birefringent film (104). Further, the partial reflector (108), the display (102), and the birefringent film (104) are adhered to each other via one or more adhesive layers. Further, the partial reflector (108) is configured to receive the at least partially polarized light emitted by the display (102). Further, the partial reflector (108) is configured to transmit incident polarized light to the birefringent film (104). The partial reflector (108) may transmit at least 30% of normally incident polarized light to the birefringent film (104). In some embodiments, the partial reflector (108) may reflect at least 80% of normally incident polarized light. The partial reflector (108) may be a conventional partial reflector, such as a semi-transparent aluminium coating. Further, the birefringent film (104) is configured to substantially reduce the visibility of the regular optical pattern generated on the display system (100) when viewed through the polarizing film (110).

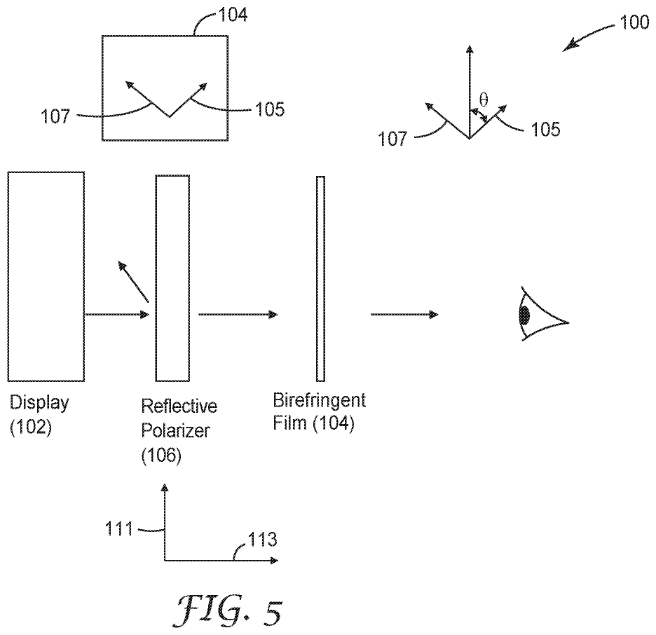

In another embodiment, as shown in FIG. 5, a reflective polarizer (106) may be disposed between the display (102) and the birefringent film (104). Further, the reflective polarizer (106), the display (102), and the birefringent film (104) are adhered to each other via one or more adhesive layers. The reflective polarizer (106) may include a wire grid polarizer. In some embodiments, the reflective polarized may include a linear polarizer. The reflective polarizer (106) may include a plurality of lower and higher index polymeric layers, each layer having an average thickness less than about 500 nm. Further, the reflective polarizer (106) is configured to receive the at least partially polarized light from the display (102). Further, the reflective polarizer (106) is configured to reflect the at least partially polarized light in a first polarization state (111). The reflective polarizer is also configured to transmit the at least partially polarized light in an orthogonal second polarization state (113) to the birefringent film (104). In an embodiment, the reflective polarizer (106) may reflect at least 80% of the incident light having a first portion having the first polarization state (111) and transmit at least 80% of the incident light having a second portion having the second polarization state (113). Further, the ratio of the first portion to the second portion may be greater than about 0.2. Furthermore, the birefringent film (104) is configured to receive the light having the second polarization state (113). As described above, the birefringent film (104) may have the retardance value of at least - nm at visible wavelength. The birefringent film (104) may be disposed on the display (102) in such a way that the birefringent film (104) has a first index of refraction along the first polarization state (111) direction and a second index of refraction, different than the first index of refraction, along the second polarization state (113) direction. Further, the difference between the first and second indices of refraction may be at least 0.05. In an embodiment, the birefringent film (104) may be disposed on the display (102) such that the orthogonal in-plane first axis (105) makes an angle (θ) between 20 to 60 degrees to the direction of the second polarization state (113). In some embodiments, the angle (θ) may be about 45 degrees.

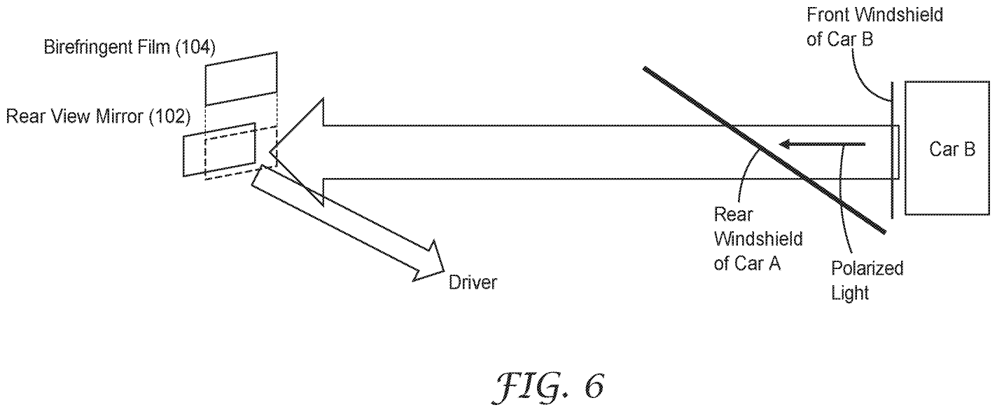

In an exemplary embodiment as best shown in FIG. 6, consider a car A leading a car B. Further, light gets polarized after striking front wind shield of the car B, and gets reflected into rear wind shield of the car A. The reflection of polarised light into the rear wind shield generates a regular optical pattern (white dot pattern) and the same is seen in a top rear view mirror by a driver wearing a polarizing sun glass. Providing a multi-layer film (104) on the top rear view mirror (102) substantially reduces a visibility of a regular optical pattern generated on the mirror (102) when an at least partially polarized light in a wavelength range extending at least from about 450 nm to about 700 nm is substantially normally incident on the mirror (102).

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific Embodiments shown and described without departing from the scope of the present disclosure. This application is intended to cover any adaptations or variations of the specific Embodiments discussed herein. Therefore, it is intended that this disclosure be limited only by the claims and the equivalents thereof.

1. A display system comprising:
a display configured to emit an image;
a birefringent film disposed on the display and having a retardance of at least 50 nm at a visible wavelength in a wavelength range extending at least from about 450 nm to about 700 nm; and
a reflective polarizer disposed between the display and the birefringent film, the reflective polarizer configured to transmit the image emitted by the display, substantially reflect a first polarization state, and substantially transmit an orthogonal second polarization state.

2. The system according to claim 1, wherein the birefringent film has an average thickness greater than about 50 microns, wherein the birefringent film has a first index of refraction along the first polarization state and a second index of refraction, different than the first index of refraction, along the second polarization state, and wherein a difference between the first and second indices of refraction is at least 0.05.

3. The system according to claim 1, wherein the birefringent film has an orthogonal in-plane first and second optical axes, the first optical axis making an angle (θ) between 20 to 60 degrees with the second polarization state, and wherein the display, the birefringent film, and the reflective polarizer are adhered to each other via one or more adhesive layers.

4. A display system comprising:
a display configured to emit an image;
a birefringent film disposed on the display and depolarizing an incident polarized light by at least 30%; and
a reflective polarizer disposed between the display and the birefringent film, the reflective polarizer configured to transmit the image emitted by the display, substantially reflect a first polarization state, and substantially transmit an orthogonal second polarization state.

5-6. (canceled)

7. A multilayer film comprising:
a partial reflector;
a birefringent film bonded to the partial reflector and having an average thickness greater than about 100 microns, such that, when viewed through a polarizing film, the birefringent film substantially reduces a visibility of a regular optical pattern generated on the multilayer film when an at least partially polarized light is incident on the multilayer film, wherein the partial reflector transmits at least 30% of normally incident polarized light, and wherein the partial reflector reflects at least 80% of normally incident polarized light.

8. The multilayer film according to claim 7, wherein the regular optical pattern comprises alternating darker and brighter regions.

9. The multilayer film according to claim 7, wherein the regular optical pattern comprises a two-dimensional periodic pattern.

10. The multilayer film according to claim 7, wherein the birefringent film has an average thickness greater than about 200 microns.

11. The system according to claim 4, wherein the incident polarized light is at least partially polarized.

12. The system according to claim 4, wherein for normally incident light in a wavelength range extending at least from about 450 nm to about 700 nm and having the second polarization state, the reflective polarizer transmits at least 80% of the incident light, the transmitted light having a first portion having the first polarization state and a second portion having the second polarization state, a ratio of the first portion to the second portion greater than about 0.2.

13. The system according to claim 4, wherein the birefringent film has an average thickness greater than about 50 microns.

14. The system according to claim 4, wherein the birefringent film has an average thickness greater than about 100 microns.

15. The system according to claim 4, wherein the birefringent film has an average thickness greater than about 200 microns.

16. The system according to claim 4, wherein the birefringent film has a first index of refraction along the first polarization state and a second index of refraction, different than the first index of refraction, along the second polarization state.

17. The system according to claim 4, wherein a difference between the first and second indices of refraction is at least 0.05.

18. The system according to claim 4, wherein the birefringent film has an orthogonal in-plane first and second optical axes, the first optical axis making an angle (□) between 20 to 60 degrees with the second polarization state.

19. The system according to claim 4, wherein the angle is about 45 degrees.

20. The system according to claim 4, wherein the display, the birefringent film, and the reflective polarizer are adhered to each other via one or more adhesive layers.

21. The multilayer film according to claim 7, wherein the birefringent film is bonded to the partial reflector.

22. The multilayer film according to claim 7, wherein the regular optical pattern comprises a periodic pattern.
